(19) United States
(12) Patent Application Publication
(10) Pub. No.: US 2013/0034837 A1
(43) Pub. Date: Feb. 7, 2013

(54) SYSTEMS AND METHODS FOR TRAINING AND ANALYSIS OF RESPONSIVE SKILLS

(71) Applicants: Wesley C. Clapp, Lincoln, MA (US); Brian T. Miller, Cambridge, MA (US); Timothy Verstynen, Pittsburgh, PA (US)

(72) Inventors: Wesley C. Clapp, Lincoln, MA (US); Brian T. Miller, Cambridge, MA (US); Timothy Verstynen, Pittsburgh, PA (US)

(73) Assignee: NeuroScouting, LLC

(21) Appl. No.: 13/335,521

(22) Filed: Dec. 22, 2011

Related U.S. Application Data
(60) Provisional application No. 61/515,775, filed on Aug. 5, 2011.

(51) Int. Cl. G09B 19/00

(52) U.S. Cl. 434/247

(57) ABSTRACT

A method for training is disclosed. The method may include providing, by a computer system, and interactive graphical simulation that can elicit a response, from a user, specific to a responsive skill for which training is desired. Based upon the response collected by the computer system, a threshold performance level of the user in at least one subcomponent skill of the responsive skill may be determined. A difficulty level of the simulation may be set to a level above the threshold performance level of the subcomponent skill, so that subsequent use of the simulation targets training in the subcomponent skill in order to enhance performance of the user in the desired responsive skill. Systems and programs for training are also disclosed.

### RELATED APPLICATIONS

This application claims priority to and the benefit of U.S. Provisional Application No. 61/515,775, filed Aug. 5, 2011, which is incorporated herein by reference in its entirety.

### FIELD OF THE DISCLOSURE

This disclosure relates to the field of neuroscience. Particularly, the present disclosure relates to neuroplasticity-based training systems and methods, that can train a user in a responsive skill. More particularly, the present disclosure relates to processes that can divide responsive skills into their subcomponent neural functions, measure the performance capabilities of each of these brain systems, and provide a training program that can improve performance in the skill by increasing performance in one or more of the subcomponent neural functions.

### BACKGROUND

Neural plasticity, often referred to as neuroplasticity, refers to the ability of the brain to change its structure and functionality in response to input from its environment. Plasticity occurs on a variety of levels, from cellular changes related to learning, to large scale cortical remapping in response to injury or stroke. Such changes can include learning, memory, and recovery from brain damage.

Exposure to a particular environment or stimulus can also elicit changes in the brain. This is one reason why athletes, for example, can improve performance through practice. Practice can improve responsive skills, i.e. skills that require a reactive and/or proactive response from a user, because repetitive exposure and successful reaction to a stimulus, hitting a baseball for example, can allow the brain to change its structure in order to improve the skill.

Sensory motor skills involve the interaction between the brain and the physical body. Neural systems in the brain control movement of the body. Such movement can be a reaction to external stimulus, and training by exposure to such stimulus can result in neural changes. Hand-eye coordination related to sports is an example. In such a case, an athlete may observe a stimulus, such as a thrown ball. The stimulus can include watching the windup of a pitcher, watching the release of the ball, and following the trajectory, speed, and spin of the ball. The brain of the athlete may then process what is observed, and in response, the athlete may decide to perform a particular motor response, which could include swinging, not swinging, or how to swing.

Training techniques for improving responsive performance typically focus on repetitive exposure to a stimulus at a macro-level. For example, the baseball player above may expose him or herself to pitch after pitch in order to improve batting performance. A race-car driver may spend hours at the race track in order to improve his or her ability to react to turns and other vehicles. However, such training does not often pinpoint component subsystems which may be inhibiting performance. For example, if a batter is having trouble with a particular component of batting, such as timing or inhibitory control, throwing pitch after pitch may not be as efficient as a training program that specifically targets the particular component.

While training through repetition of the responsive skill can result in increased performance in the macro-skill, it may be more beneficial to train subcomponent skills that correlate to subcomponent brain systems in order to more efficiently improve performance in the macro-level skill. This is because training in the subcomponent skill can allow the brain to change its structure and performance in component areas that will most increase performance in the macro-skill. For example, subcomponent skills of batting that correlate to subcomponent brain systems can include timing (when to swing), inhibitory control (when not to swing), and visuo-location (spatial tracking of the ball). If a batter is strong in timing and visuo-location, then that batter may wish to focus his or her training in the area of inhibitory control. A training schedule that attempts to improve the weakest subcomponent skills may provide better, more efficient improvement in the macro-skill, because it targets training toward those subcomponent brain systems of the batter that will most improve batting performance.

One way to train a responsive skill is to engage a user through the use of a computer platform. The computer can provide a simulated environment designed to challenge a responsive skill of a user. Unfortunately, typical computer simulations merely provide repetitive training in a macro-skill, despite the potential of these platforms to increase performance in subcomponent skills, and thereby target training toward particular subcomponent brain systems.

### SUMMARY

In an embodiment, a method, computer program, and/or process for training may include providing, by a computer system, and interactive graphical simulation that can elicit a response, from a user, specific to a responsive skill for which training is desired. Based upon the response collected by the computer system, a threshold performance level of the user in at least one subcomponent skill of the responsive skill may be determined. A difficulty level of the simulation may be set to a level above the threshold performance level of the subcomponent skill, so that subsequent use of the simulation targets training in the subcomponent skill in order to enhance performance of the user in the desired responsive skill.

In some embodiments, the user may be able to choose the subcomponent skill in which to train so that the user can target a specific subcomponent skill in which to improve performance.

A custom training program can be generated, based on the threshold performance level of the user. The training program can be tailored to improve performance of the user in the subcomponent skill, so that subsequent use of the training program will enhance the performance of the user in the responsive skill.

A pass/fail criteria can be set for the simulation. Such a pass/fail criteria can be used to measure a difficulty level at which the user fails at the simulation, so as to determine the threshold performance level of the user. The pass/fail criteria can be used to fine-tune the threshold performance level by incrementally adjusting the level of difficulty in either direction from the threshold performance level. Whether the user passed or failed the simulation can then be measured, at the adjusted level of difficulty, in order to obtain a more accurate measurement of the threshold performance level.

In an embodiment, a plurality of threshold performance levels can be measured and compared to historical performance levels of a baseline population, in order to identify a set of subcomponent skills in which the user is weak. A training program weighted toward those subcomponent skills in which the user is weak can then be generated, so that use of the training program will improve performance of the user by providing focused training in those subcomponent skills.

The difficulty level can, in an embodiment, be adjusted as the performance threshold of the user changes, so that the user is continuously challenged by the simulation and can continue to increase performance through use of the simulation. The current threshold performance level of the user can be stored in a memory or other storage device once a training session ends, so that such threshold performance level can be used for subsequent training sessions. The threshold performance levels of the user can be made available so that a scout can compare the ability and/or potential of the user to other possible recruits, so a trainer can create a custom training program for the user, so the trainer can monitor the user performance over time, or for any other reason.

In an embodiment, the simulation can be used for training in a variety of responsive skills, including, but not limited to, training a sensory-motor skill, training of a non-sensory motor skill, training of a sport activity, training of a non-sport activity, medical rehabilitation, or a combination thereof.

### BRIEF DESCRIPTION OF THE DRAWINGS

Exemplary embodiments are described herein with reference to the drawings, in which:

FIG. 1 is a computer system architecture;

FIG. 2 is an architecture of a processing device;

FIG. 3 is a block diagram of a training process;

FIG. 4 is a visual display of a training simulation;

FIGS. 5 and 5a are graphical depictions of data collected by the training process; and

FIG. 6 is a graphical depiction of data collected by the training process.

### DETAILED DESCRIPTION

The present invention provides, in an embodiment, a training system for improving performance of a responsive skill that involves a reactive or proactive response from a user (i.e. a “responsive skill”). The response from the user can be based on sensory and/or non-sensory input. Examples of such as skill include, hitting a baseball (i.e. a reactive skill), anticipating a pitch based on a pattern of pitches (i.e. a proactive skill), or answering a question (i.e. a proactive skill). As will be discussed below, the system may provide training in subcomponent skills of the responsive skill that are associated with subcomponent brain systems. Training the subcomponent brain systems in the subcomponent skills can increase a user performance in the complex skill of an individual. Such a training system can, in an embodiment, be implemented in a computing environment.

### Definitions:

As used herein, the term “responsive skill” may refer to a skill that involves a reactive and/or proactive response from a user. The term “responsive skill” is intended to include, but is not limited to, sensory motor skills where a user response may be linked to a sensory input and rapid-decision making skills. Examples of sensory motor skills include, but are not limited to, visuo-motor skills such as hitting a baseball, receiving a pass, avoiding an obstacle, etc., audio-related skills such as a musician playing music in response to what is being played by other musicians, tactile-related skills such as a bobsledder reacting to motion of the bobsled, taste-related skills such as a chef determining how to modify a dish during cooking, and olfactory related skills such as a fire-fighter's reaction to the smell of a gas leak. Unless specifically stated, the terms “responsive skill,” “macro-level skill,” “macro skill,” and “complex skill,” as well as variations, synonyms, and combinations of those terms, may be used interchangeably herein.

As used herein, the term “subcomponent skill” may refer to a component of a responsive skill that is used to respond to a stimulus. For example, when responding to a stimulus, a user may call upon various subcomponent skills that, in whole or in part, make up the response of the user. In the example of hitting a baseball, the responsive skill of swinging the bat may be made up of “subcomponent skills” such as timing (when to swing), inhibitory control (when not to swing), spatial tracking (where to swing the bat), and/or many other subcomponent skills. In the example of musical improvisation, the responsive skill of playing an improvised tune may be made up of “subcomponent skills” such as musical timing (when to play a note), recognition of pitch (identification of the notes that are played by fellow musicians), playing in pitch (determination of which notes to play), musical progression (anticipation of which notes will be played in a progression by a fellow musician) and/or many other subcomponent skills. Failure or poor performance in a subcomponent skill, or a combination of subcomponent skills, can lead to failure or poor performance in the overarching responsive skill. Similarly, improvement in any subcomponent skill, or combination of subcomponent skills, can lead to improvement in the responsive skill. Unless specifically stated, the terms “subcomponent skill,” “sub-skill,” and “component skill,” as well as variations, synonyms, and combinations of those terms, may be used interchangeably herein.

As used herein, the term “breakdown point” may refer to the point at which a user is unsuccessful at performing a subcomponent skill. The term should be understood to be any criteria that can be set, arbitrarily, systematically, or otherwise, to measure and/or determine success of a user in performing a subcomponent skill. Examples include fail percentage, pass percentage, quality of performance, accuracy of performance, precision of performance, and the like. The term “breakdown point” can also be used to refer to a point at which a user is unsuccessful at performing a responsive skill. A “breakdown point” can be based on measured data, historical data, or any other data. Unless specifically stated, the terms “breakdown point,” “failure point,” “threshold performance level,” as well as variations, synonyms, and combinations of those terms, may be used interchangeably herein.

As used herein, the term “Performance Zone Detection (PZD)” may refer to any process, technique, or other activity for testing performance of a user in a subcomponent skill in order to identify a user breakdown point (i.e. a threshold performance level). In some embodiments, the breakdown point (i.e. threshold performance level) can be determined by a computer system, by software, by a processor, etc. In some cases, the breakdown point can be represented by data, which can be stored in a database, memory, or other storage medium. The term “Performance Zone Detection” can also refer to process, technique, or other activity for testing performance of a user in a responsive skill in order to identify a user breakdown point

As used herein, the term “Performance Threshold Identification (PTI)” may refer to any process, technique, or other activity for fine-tuning a breakdown point measurement in order increase the accuracy of the breakdown point measurement.

### System Architecture

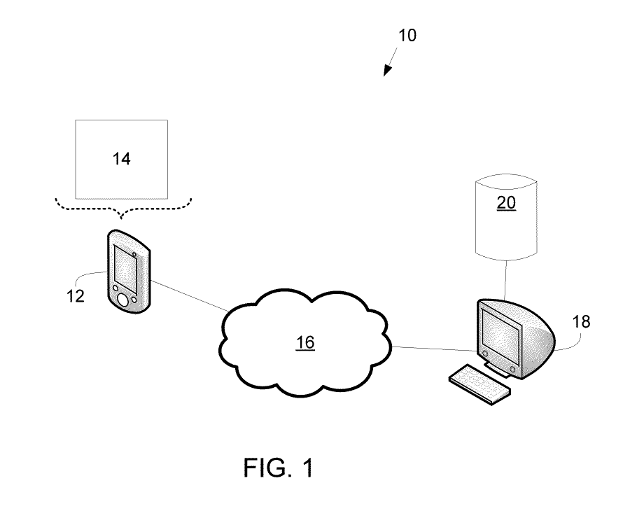

Referring now to FIG. 1, in an embodiment, the present invention provides a system and architecture 10 for training The system may include a computing device 12, which may execute training application 14. Computing device 12, in one embodiment, may be any type of computing device including, but not limited to, a computer, a laptop, a game console, a medical display device, a television, a portable game device, a cell phone, a smart phone, a tablet, a home appliance, a processor-enabled toy, a game controller, or any other device capable of executing training application 14.

In some embodiments, computing device 12 may be connected to network 16 so that computing device 12 can communicate with other devices connected, directly or indirectly, to network 16. Network 16 may be a local network, a wide area network, a business network, a home network, the internet, a telephone network, a wireless network, a wired network, or any type of network, or combination of networks, that allows computing devices (such as computing device 12 and server 18, or other devices) to communicate with each other. Additionally, network 16 can employ any type of communication protocol, including, but not limited to: Ethernet, token-ring, IEEE 802.x, cellular protocols, etc.

System 100 may also include a server 18. Server 18 can be any type of computing device including, but not limited to, a server, a desktop computer, a laptop computer, a handheld computer, a game console, a tablet, etc. In some embodiments, server 18 may provide database services so that training application 14 can access data within database 20. As will be discussed, database 20 can hold performance data related to the performance of an individual user, or the performance of a group of users. In an embodiment, at least some of the data in database 20 can represent performance or other information for an elite group of users, such as professional athletes, in a responsive skill.

Although not shown, server 18 and computing device 12 can, in some embodiments, be the same device. In such an embodiment, application 14 and database 20 may reside on the same device so that communication over an external network 16 is not needed.

### Computer Processing Device

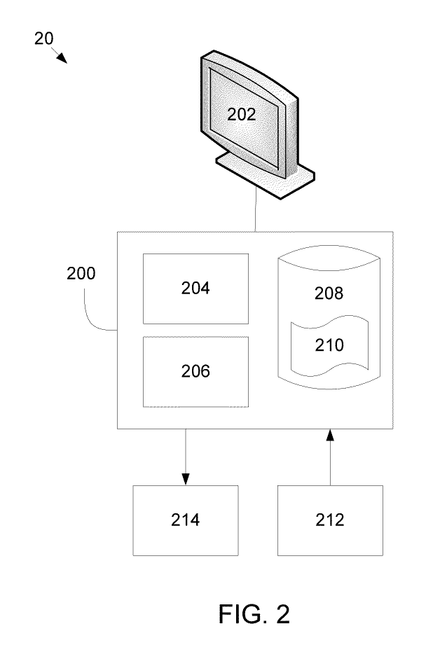

The present invention may be implemented as hardware, software, or a combination thereof. FIG. 2 shows a block diagram of a typical processing device 200, which may be able to execute software and applications associated with the present invention. Computer processing device 200 may be coupled to display 202, which may provide graphical output to a user. Processing device 200 can include a processor 204, which may be any type of computer processor capable of executing software. Typical examples of processor 204 are computer processors (such as Intel® or AMDC® processors), ASICs, microprocessors, and the like. Processor 204 may coupled to memory 206, which is typically a volatile RAM memory for storing instructions and data while processor 204 executes. Processor 204 may also be coupled to storage device 208, which may be a non-volatile storage medium, such as a hard drive, FLASH drive, tape drive, DVD-ROM, or similar device. Processing device 200 can also include program 210, which can be a computer program residing in a computer storage medium such as storage device 208 or memory 206. Program 210 can contain instructions for training a user in a skill. Program 210 may typically be stored within storage device 208, but can also be stored in any computer readable storage device. In an embodiment, processor 204 may load some or all of the instructions and/or data of program 210 into memory 206 for execution. Of course, processor 204 can also execute program 210 directly from storage device 208. Program 210 can be any computer program or process including, but not limited to training application 14.

In an embodiment, program 210 may include various instructions and subroutines, which, when executed by processor 204 can cause processor 204 to perform various operations, some or all of which may effectuate the methods associated with the present inventions.

Processing device 200 may also include various input and output devices, so that a user can receive stimulus from, and provide a response to processing device 200. The input devices 212 can include keyboards, computer mice, buttons, game controls, microphones, cameras, accelerometers, touchpads, touchscreens, tilt sensors (e.g. to detect tilt in a game controller or mobile device), joysticks, D-pads, cameras, video cameras, body motion input devices such as the Microsoft® Kinect® device, or any other type of input device that allows a user to provide input to processing device 200. Input devices 212 can be physically or wirelessly coupled to processing device 200 through any means known in the art.

Similarly, the output devices 214 can include video monitors, touchscreens, speakers, vibration feedback devices, lights and LEDs, or any other type of output device. Like the input devices 212, output devices 214 can be physically or wirelessly coupled to processing device 200, and may communicate with processing device through any means known in the art.

Other input and output devices coupled to processing device 200 may include network adapters, USB adapters, Bluetooth radios, mice, keyboards, touchpads, displays, touch screens, LEDs, vibration devices, speakers, microphones, sensors, or any other input or output device for use with computer processing device 200.

### Training Process

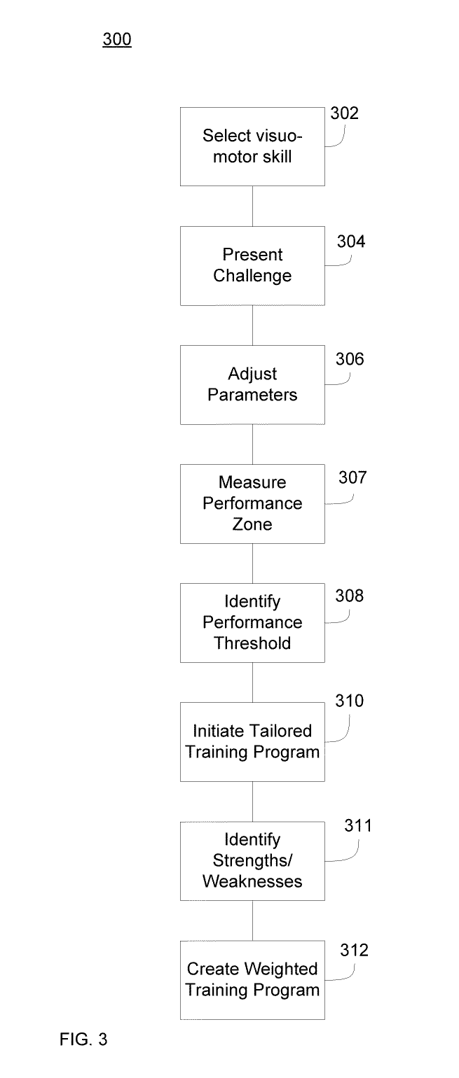

FIG. 3 shows a flowchart of a training process 300 for training a user. Process 300 can, in an embodiment, be implemented wholly or partially in a hardware and/or software system, such as those described above. In another embodiment, training process 300 may be implemented, in whole or in part, in any embodiment that can provide the training techniques described herein.

The training process 300 may be designed to train a user in any responsive skill where a user provides a reactive or proactive response to a stimulus. A responsive skill can be a sensory motor skill, where a user responds to sensory input. Examples include visuo-motor, where the response of the user is tied to visual input. Such skills can include sporting skills, such as batting, catching, passing, receiving a pass, avoiding a tackle, reacting to the location of other players, etc, as well as non-sporting visuo-motor skills, such as driving, avoiding obstacles, etc. Sensory-motor skills can also include skills where a user responds to other sensory inputs, such as sound, feel, taste, or smell. Examples can include a musician playing improvisational music (sound), a commuter attempting to balance on a moving commuter train (feel), a chef making rapid decisions as to how to prepare a dish during cooking (taste), or a firefighter reacting to the smell of a burning substance (smell).

Training process 300 can also provide training in decision-related responsive skills such as answering a question, making fast-paced business decisions, speech related skills, or any other non-sensory input reactive skill.

In an embodiment, process 300 can be used to train someone with brain damage, such as a stroke or head injury victim, or individuals suffering from neuropsychiatric conditions such as Attention-Deficit and Hyperactivity Disorder (ADHD), to improve brain function.

As shown in FIG. 3, training process 300 may, in some embodiments, allow a user to select a responsive skill in which he or she wishes to train, as shown by box 302. The responsive skill, as described above, can be any responsive skill that requires a reactive or proactive response from a user. To allow the user to select, training process 300 may present a list of responsive skills to the user. The list may be part of a graphical user interface (GUI), or may be presented in any other way that allows the user to select a responsive skill. Typically, the list will include responsive skills such as batting, catching, etc. However, the list can also include subcomponent skills such as timing, inhibitory control, spatial tracking, and the like.

Once the user has selected the responsive skill, training process 300 may then present a training exercise to the user. The training exercise may include a series of training modules that correlate to subcomponent skills of the responsive skill. For example, if the responsive skill is batting, the training exercise may test user performance in timing, inhibitory control, spatial tracking, and other subcomponent skills that relate to batting. Process 300 can present these training modules serially, or in any order. Alternatively, if a user wishes to train in a particular subcomponent skill, the user can choose the subcomponent skill (from a GUI list, for example). Process 300 may then present the chosen module and allow the user to train specifically in the chosen subcomponent skill.

The training exercise may be a simulated environment that presents a stimulus to the user and allows the user to respond. The user may respond to the stimulus by providing any type of user input, including, but not limited to: button presses, keyboard input, mouse movement, game controller input, oral actions such as speaking or yelling, body movements, eye movements, etc. For example, if the user selected batting as the responsive skill to train, the training exercise may render a video or graphic that simulates a baseball pitch. The user may respond by simulating a swing by, for example, pushing a button that represents the swing of the bat. One skilled in the art will recognize that the response can be provided in a variety of ways, and is not limited to a button press. For example, the user could swing a Wii® controller, make a gesture that can be captured by tracking platforms (e.g. the Microsoft Kinect®) or other wireless controllers to simulate a swing. The gesture may be made while holding a bat, another object that simulates a bat, or without holding an object, for example.

As the user responds, training process 300 may measure the response and record information related to the response. The information can include whether the user responded or refrained from responding, timing information related to the response, or any other information related to the response, and depending upon the subcomponent brain system being tested. In some embodiments, the information can include a variance or variability of the response. Variance data can provide information and insight as to how precise or repeatable the response of the user is. Such information can indicate whether there is room to for the user to improve, or how much potential there is for the user to improve, in his or her response. Of course, such information can be used to develop a training program that targets those areas where there is the potential for the user to improve, in order to make the training program more effective at improving performance.

Training process 300 can also record information about the simulated environment. For example, if the environment simulates a baseball pitch, process 300 can record information such as the speed of the pitch, the location of the pitch, the trajectory of the pitch, or any other information about the simulation. Other information about the simulated environment can also be recorded, such as the brightness of the simulation, information about any sound or background image played by the simulation, the date and time, information about the user, etc. The recorded information can then be stored for processing.

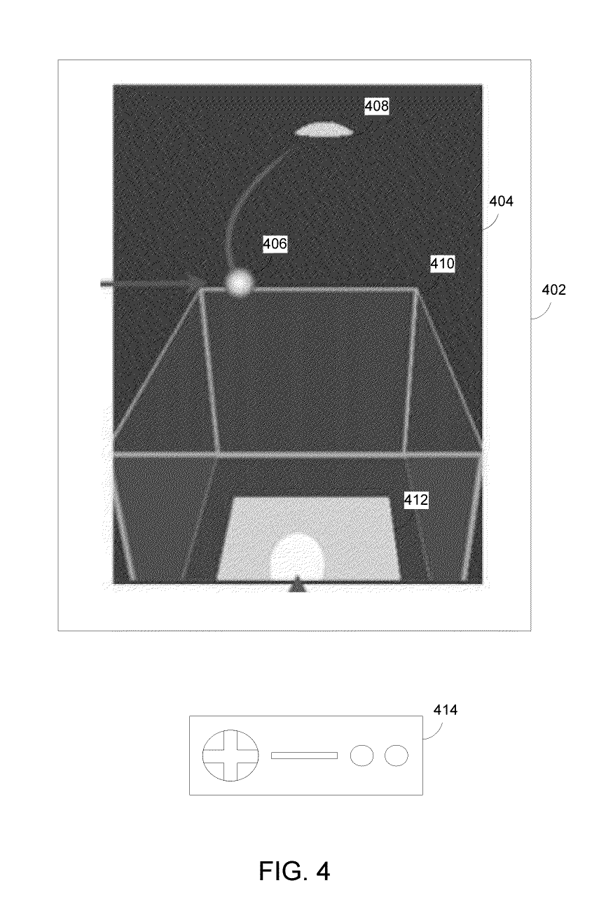

FIG. 4 shows an example of a simulated training exercise that represents a baseball pitch. In FIG. 4, display screen 402 displays baseball simulation 404. Baseball simulation 404 may be a video or graphic in which ball 406 travels from pitching mound 408 toward strike zone 410 and home plate 412. During the simulation, a user can press a button or other switch on input device 414 to simulate a swing of the bat. As discussed above, training process 300 can record information about the simulation and the environment for future processing.

Turning back to FIG. 3, as training process 300 presents the simulated training exercise, it can adjust parameters of the training exercise to measure specific subcomponent skills related to the chosen responsive skill, as shown by block 306. Rather than focusing on a macro-level responsive skill, training process 300 may focus on measuring and training subcomponent skills related to the macro-level responsive skill. Again, using batting as an example, instead of measuring an overall response to a pitch, training process 300 may split the macro-skill of batting into component subcomponent skills that correlate to trainable subcomponent brain systems related to batting, such as timing, inhibitory control, spatial tracking, or other subcomponent skills. For example, if process 300 is measuring timing, it may be more important to determine how well the user responds to variations in timing of the ball, rather than how well the user hits a ball overall. Of course, training process 300 can measure and determine performance in other parameters and subcomponent skills as well, such as how well a user can inhibit a swing, how well a user can visually track the trajectory of the ball, etc.

In some embodiments, process 300 can parse the responsive skill into the subcomponent brain systems for training In an example, process 300 can use data from current and past neuroscience imaging research, such as magnetic resonance imaging (MRI), magneto encephalography (MEG), electroencephalography (EEG) to determine what sensory stimuli (visual stimuli is an example) activate or change a specific network or subcomponent brain system that comprise of a neural subsystem. In an example, a skill like hitting a baseball may involve a myriad of neural subcomponent subsystems to be successful. Process 300 can use neuro-imaging and neuroscience research to break down the different stages of processing that must be called upon to successfully hit a ball (in an example, early visual recognition, mapping this recognition to the correct action, perceptual-action timing, and inhibitory control and adjustment networks that could be called upon to adjust or call off an action if a violation is detected). Failure at any of these skills can lead to failure at the macro-level responsive skill (i.e. in this example, a swing and a miss), and thus training at a high-level of this complex skill may not be as effective as isolating each subcomponent brain system that underlies the skills that have been laid out in the example above. Accordingly, process 300 can provide modules for isolating and training the subcomponent brain systems and subcomponent skills that underlie a complex responsive skill.

As an example, FIG. 4 shows a simulated environment 402, that can be displayed on a computer display, and that can be used to train various subcomponent skills related to batting. As shown, the environment 402 may simulate a baseball pitch by animating the flight trajectory of ball 406 toward strike zone 410. A user may be instructed to “swing” (e.g. press a button or provide another type of input) when ball 406 enters strike zone 410. In order to measure and train the subcomponent skills related to batting, such as timing, process 300 may simulate multiple pitches with varying speed. Process 300 can measure the timing of the swing in order to measure user performance and train the user in subcomponent skills related to timing.

Environment 402 can also be used to train a subcomponent skill related to inhibitory control. In this case, the user may be instructed to swing the bat for each pitch, but to stop from swinging if a stop signal appears. The stop signal could be any visual or auditory signal generated by process 300, such as a beep, a flash, or a change in the color of ball 406 during its flight. In one example, the user may be instructed to stop his or her swing if the ball turns red before it reaches strike zone 410. Process 300 can measure the ability of the user to refrain from swinging under such varying circumstances.

Environment 402 can also be used to train a subcomponent skill related to spatial tracking In this example, the user may be instructed to swing if the ball enters the strike zone, and to refrain from swinging if the ball's trajectory takes it outside the strike zone. Process 300 can simulate multiple pitches with varying trajectories to measure how well or how quickly the user can respond to the location of the ball during flight. Environment 402 can also change other parameters, such as the size of the strike zone, the size of the ball, etc., to measure the performance of the user.

Although three examples of subcomponent skills have been described above, one skilled in the art will understand that any number of subcomponent skills related to baseball can be trained by process 300. Additionally, process 300 can present simulations and measure subcomponent skills related to other sports, such as hockey, football, tennis, soccer, basketball, etc., as well as simulations that can train a user in subcomponent skills related to non-sporting activities such as driving, avoiding obstacles, playing music, medical rehabilitation, playing video games, military exercises and engagements, balancing, etc.

By adjusting subcomponent skill parameters, training process 300 can identify a breakdown point. The breakdown point, in some embodiments, may be defined as a difficulty level at which the performance of the user in a subcomponent skill breaks down, and can be based on a success rate, or other success criteria, such as a pass/fail criteria, for example. In an embodiment, the breakdown point may be defined as the difficulty level at which a user fails at a training simulation 50% of the time. Of course, the success rate could be set at any percentage level. The breakdown point can also be defined with other measurements, such as how precise the responses are, the difference between the user responses and a threshold criteria, the difference between the user responses and the mean or average response from a population, or based on any other measured and/or statistical criteria.

One skilled in the art will recognize that it may be desirable to set the success criteria so as to maximize training of a subcomponent brain system related to the subcomponent skill that is being measured. In some cases, changes in subcomponent brain systems that increase performance in the subcomponent skill, and therefore increase performance in the macro-level responsive skill, may occur more rapidly if the brain is challenged at a level just above its current skill level. If the training scenario is too easy or too hard, there may not be a sufficient reward for success to stimulate performance improvement. However, if the challenge is set to a point just above the current skill level, success in the training exercise may chemically reward the brain, for example by releasing neuro-chemicals such as dopamine. Chemical or other physiological rewards such as these can cause reward-related changes to the subcomponent brain system responsible for the subcomponent skill. These changes can include neuro-generation, changes in synaptic branching, or increases in the number of neuro-receptors, for example.

As the user becomes better at a particular subcomponent skill, the difficulty level of the training exercise can be set or modified in order to maximize the brain-related rewards received from the training, and thereby maximize the effectiveness of the training For example, as a user trains, his or her performance level may increase or decrease. Accordingly, process 300 may continuously or periodically adjust the difficulty level, or breakdown point, so that the brain is continuously challenged at a level just above its current performance level.

One skilled in the art will recognize that the difficulty level can be represented by data such as a parameter, or a plurality of parameters, in software. These difficulty parameters can be set or modified by a computer system, software, a processor, etc. In some cases, these difficulty parameters can be stored in a database, a file, a memory, or any other storage medium so they can be accessed by process 300, or by a software application.

Measuring the breakdown point can be a two step process. In the first step, process 300 can Detect a Performance Zone (Performance Zone Detection—PZD) to initially find a breakdown point of the user. In the second step, process 300 can Identify a Performance Threshold (Performance Threshold Identification—PTI) to fine-tune the breakdown point measurement.

The PZD process may consist of sweeping the difficulty of a subcomponent skill across a difficulty range to determine a difficulty level where the user is no longer successful at the subcomponent skill. In some cases, in order to measure the performance, training process 300 may adjust difficulty parameters related to the subcomponent skill. For example, training process 300 may sweep the difficulty level of the subcomponent skill by continually increasing or decreasing the difficulty of the subcomponent skill, and recording responses from the user. As an example, if the subcomponent skill being measured is timing, process 300 may present the user with increasingly difficult timing scenarios, which can include increasingly fast pitches, increasingly difficult slow pitches (e.g. change-ups), etc. Of course, the training exercise can also be presented with decreasing difficulty, random changes in difficulty, or any other variations that can vary the difficulty of the subcomponent skill. In an embodiment, changes in difficulty can be randomly or pseudo-randomly modified from simulation to simulation so that a user cannot predict the changes in difficulty during the measurement process. In such a case, a relatively difficult trial may be equally likely to be followed by an extremely easy trial as it is to be followed by an incrementally more difficult trial, for example. This may provide more accurate responses from the user by minimizing or preventing the user from recognizing and following patterns of difficulty during the simulation. Training process 300 can also measure the response of the user multiple times at various difficulty levels in order to obtain more data samples from the user. The data samples can then be processed statistically in order to provide an accurate estimation of the performance of the user.

In an embodiment, process 300 can utilize recorded data to modify the difficulty level. For example, database 20 may contain information about which simulation parameters can be modified in order to increase or decrease the difficulty level. In some cases, the information can be based on what a base population of users have found difficult in the past. For example, in the batting example, the recorded data may include information about how difficult past users find a particular combination or sequence of pitches, or a particular change in timing between pitches. As an example, the data may show that, according to a base population, it is most difficult to successfully hit a 78 mph change up when it is thrown immediately after a 93 mph fastball, but that it is slightly easier to hit the 78 mph change up when it is thrown immediately after an 85 mph slider. Accordingly, process 300 can use such past-recorded data to vary the difficulty level of the simulation.

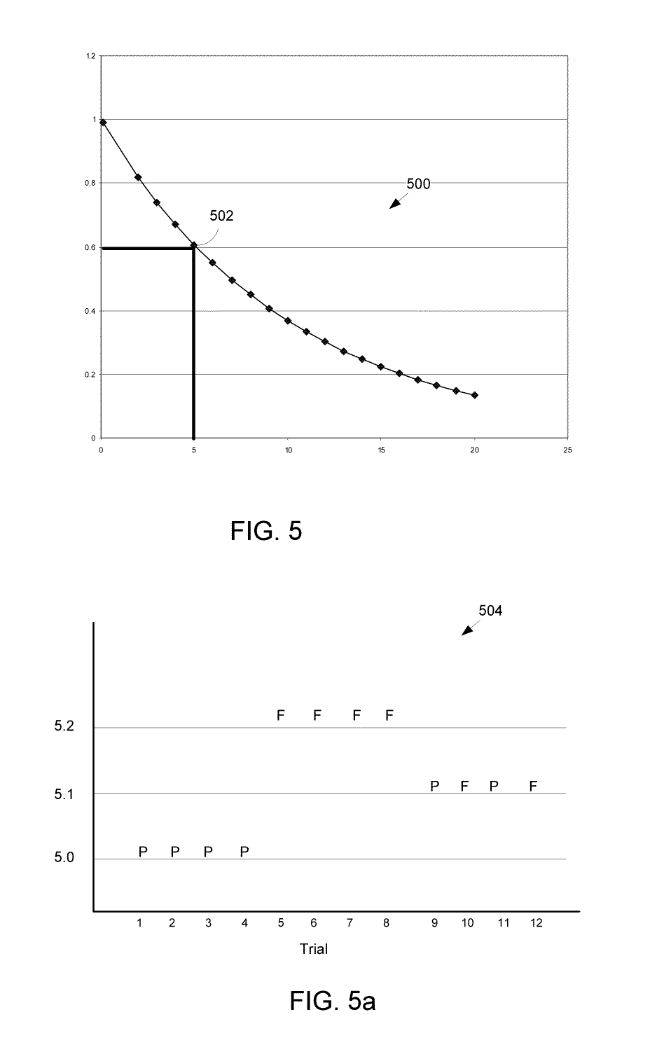

FIG. 5 shows an example of a performance curve 500 that illustrates PZD. In FIG. 5, the horizontal axis may represent the difficulty level of the subcomponent skill, and the vertical access may represent a success rate obtained by a user. As process 300 tests the performance of the user across the difficulty range, it can collect data representing the performance of the user. In this example, the user performance is graphed as curve 502. As shown, based on curve 502, if the success rate is set at 60%, the PZD process may identify a difficulty level of 5 as the breakdown point. Of course, this is a simplified example—actual measured data may show various different curves and performance characteristics, and the success criteria may be based on any type of data and set to any value.

Once process 300 detects the performance zone of a user, process 300 may

Identify a Performance Threshold (PTI), as shown by box 308. The PTI process may fine-tune the breakdown point measurement to obtain a more accurate result. In other words, instead of testing the user over a broad range of difficulty levels, process 300 may now attempt to more accurately measure, or fine-tune, the breakdown point. To do so, process 300 may proceed through one or more phases of measuring the response of the user to the training exercise. Each phase may optionally begin with training process 300 setting the difficulty level to the previously estimated breakdown point (the level “5” in the previous example). Process 300 may then incrementally increase the difficulty if the user passes the challenge, or decrease the difficulty if the user fails the challenge. Based on the results, process 300 may modify or move the breakdown point of the user to correspond to the new pass/fail data. Process 300 can continue to challenge and measure the performance of the user, and adjust the breakdown point, until it determines a sufficiently accurate measurement of the breakdown point.

FIG. 5a illustrates one example of how the PTI process can fine-tune the breakdown point measurement. The chart 504 in FIG. 5a shows trials on the horizontal axis. In the batting example, each trial may correspond to a swing. The vertical axis shows the difficulty of the trial. The P's and F's in the chart indicate whether the user passed (P) or failed (F) the trial.

As described, the PTI process may begin with the previously measured breakdown point, in this case, a difficulty of 5. Trials 1 through 4 show that the user passed every trial at difficulty level 5. Accordingly, the PTI process may then increase the difficulty level to 5.2. Trials 5 through 8 in FIG. 5a show that the user failed every trial at difficulty level 5.2. Process 300 may then decrease the difficulty to 5.1. As chart 504 shows, the performance of the user flipped between passing and failing at difficulty level 5.1. This flipping can indicate that difficulty 5.1 is a more accurate measurement of the breakdown point than 5.0 because the user was only partially successful at difficulty 5.1—the user failed some of the trials and passed others. Of course, statistics and other methods of fine-tuning can be used to perform the PTI process as well.

Process 300 can continue to fine-tune the breakdown point until a certain criteria is met. The criteria can be set by a user, administrator, or designer of process 300, and can involve various statistical requirements. For example, the criteria may require that the variance of the breakdown point measurements fall below a particular maximum. As another example, the criteria may require that a difference (i.e. error) between the last breakdown point measurement and the current breakdown point measurement below a particular threshold. These examples are not meant to be limiting: the criteria for successfully measuring an accurate breakdown point can be any appropriate criteria.

External measurements can be used to improve the accuracy of the breakdown point measurement. These can include, but are not limited to: electrophysiological measurements (electroencephalography, etc.), physiological measurements (MRI/functional MRI, electrocardiogram, etc.), eye movements (eye-tracking measurements or pupillometry, etc.), and the like. Measurements from these external data sources can be captured by process 300 along with the user performance data. These external data sources can be connected or coupled to process 300, computing device 12, or server 18 for communication through techniques known in the art.

Similarly, external equipment, such as bio-feedback or neuro-feedback devices, can be used to measure the physiological state of the user. In some cases, process 300 may be configured to begin training only after a certain physiological state is reached.

Obtaining a finely tuned measurement can help to provide a more effective and efficient training program. If the breakdown point is accurately measured, the training can more accurately focus on improving performance of the subcomponent brain systems by accurately modifying the difficulty level of the simulation so it remains just above the current skill level of the user. This can result in more rapid and beneficial performance improvement when compared to traditional training techniques.

Process 300 can measure and fine-tune a breakdown point of a user for a single subcomponent skill, or for multiple subcomponent skills. The breakdown points for various skills can be measured sequentially, simultaneously, or with any appropriate measurement schedule. These results can then be stored in a database (such as database 20) for future use. In some cases, the data may be used as a measure of the present skill level of an athlete. The data may also be used to project future or potential performance of the athlete. Such information can be useful to an athletic scout to identify potential recruits.

Once the breakdown points have been identified across one or more subcomponent skills, process 300 can initiate a training program tailored to increase the performance of the user in at least one of the subcomponent skills, as shown by box 310.

To do so, process 300 can identify the strong and weak subcomponent skills of the user, as shown by box 311. In some cases, the strengths and weaknesses may be determined by comparing the performance of the user in various subcomponent skills to a desired performance. The desired performance may be set by the user, and may be based on any appropriate criteria. In other cases, the desired performance can be based on historical data collected from a baseline population of users.

One skilled in the art will recognize that the baseline population can be any group or population desired, and therefore can represent any skill level desired. For example, the baseline population can be chosen to be a group of elite or highly skilled group performers. If, for example, the baseline population is chosen as the group of all professional baseball players, then process 300 can measure the strengths and weaknesses of the user relative to the average performance of professional baseball players. Alternatively, if the baseline population is chose as a group consisting of the very best hitters in baseball, then process 300 can measure the strengths and weaknesses of the user relative to the very best hitters in baseball. Of course, process 300 is not limited to measuring baseball skills against baseball player populations: any population can be used, in any skill area desired, to determine strengths and weaknesses of the user.

In some cases, process 300 can determine how strong or weak a subcomponent skill is based on the difference between the measured performance of the user and the mean or average of a baseline population. For example, a user performance measured at three standard deviations below the mean or average may be considered very weak, while a performance measured at one standard deviation from the mean or average may be considered moderately weak. Similarly, a user performance measured at three standard deviations above the mean or average may be considered very strong, while a performance measured at one standard deviation from the mean or average may be considered moderately strong. As will be discussed below, user strength and weakness of a subcomponent skill, including strength and weakness based on distance from a mean or average, can be used to tailor a training schedule for the user. One skilled in the art will recognize that these are only examples, and that any measure of deviation can be used to determine whether a subcomponent skill is strong or weak, or how that strength or weakness compares to a population.

Such historical data can be stored in and/or retrieved from, database 20 (FIG. 1), any other database coupled to any network or device, or in any other storage medium. As an example, if the user is a professional baseball player, process 300 can compare the performance of the user to the performance of other professional baseball players stored in database 20 to determine where the performance of the user falls with respect to other professional baseball players. Of course, the user performance could also be compared to that of the general population, or to any group or population. In some cases, the baseline population can be users of the same age group, the same socioeconomic background, the same health conditions, the same skill levels, or any chosen or desired baseline population.

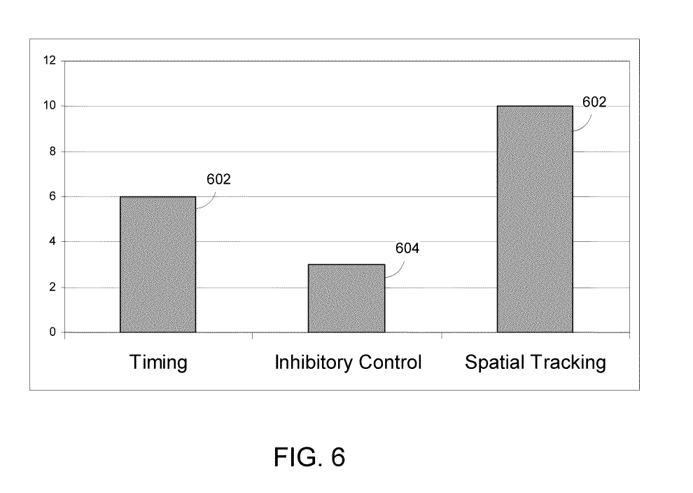

FIG. 6 shows an example of data representing a user performance in various subcomponent skills related to batting. In FIG. 6, column 602 may represent performance in the subcomponent skill of timing, column 604 may represent performance in the subcomponent skill of inhibitory control, and column 606 may represent performance in the subcomponent skill of spatial tracking As shown in the example, the performance of the user may be relatively high in spatial tracking, average in timing, and relatively low in inhibitory control.

Process 300 may utilize the relative performance of the user in these subcomponent skills to create a training program designed to improve overall performance in the responsive skill. It may be determined that, because performance in inhibitory control is lowest, the user can improve his or her batting most efficiently through a training program weighted toward inhibitory control. In such a case, process 300 can create a training program for the user that weights the training exercises in favor of exercises that improve inhibitory control. The tailored training program may, for example, train the user longer or more often in inhibitory control than in the other subcomponent skills.

Process 300 can weight the training program in a variety of ways. For example, the training program can include a schedule whereby the user receives training in the weakest subcomponent skills more often than the other skills. In such a case, the schedule can consist of a series of training sessions where the training sessions that target the weakest subcomponent skills outnumber the training sessions that target other subcomponent skills. In another example, the training sessions that target the weakest subcomponent skills can be longer than those that train other subcomponent skills.

Process 300 can also weight the training program so that subcomponent skills are trained in a way most effective at improving the subcomponent skill. For example, it may be determined that a particular subcomponent skill is improved more effectively if the user engages in multiple training sessions for that subcomponent skill. Accordingly, process 300 can create a training program that provides multiple training sessions for that subcomponent skill. As another example, it may be determined that a particular subcomponent skill is improved most effectively if the user engages in long training sessions for that particular skill. Accordingly, process 300 can create a training program that provides long training sessions for that subcomponent skill.

In yet another example, process 300 can weight the training program toward weaker subcomponent skills based on how distant the subcomponent skill is from a population mean or average. As described above, the distance of the subcomponent skill from that of a population mean or average can be used to determine how weak or strong the user performance is in the subcomponent skill. Accordingly, process 300 can weight the training program to target those subcomponent skills that are considered weakest or furthest from the mean or average.

Process 300 can also weight the training program across multiple subcomponent skills. For example, the training program may be weighted so that the weakest subcomponent skill receives the most training, the second weakest subcomponent skill receives the second-most training, etc.

One skilled in the art will recognize that the training program can include training in other subcomponent skills as well, and that the tailored training program need not be weighted toward those skills with the lowest performance. In some cases, the user may choose, for example, to train in a subcomponent skill that already has high performance if he or she believes such training will further improve performance in the macro-level skill. In other cases, the training program may provide training in subcomponent skills that already have high performance so as to maintain high performance in the subcomponent skill.

In addition, the training program can be tailored to isolate and train a single subcomponent skill, or integrate training in multiple subcomponent skills at once. In some cases, by combining the training, process 300 may facilitate neural plasticity across multiple component neural systems underlying a complex skill.

In an embodiment, the training program can be designed to challenge and train more than one subcomponent skill. For example, the training program may be designed to focus on both timing and inhibitory control, or any other combination of subcomponent skills. In such a case, the training program could provide training in one of the subcomponent skills by isolating and modifying difficulty parameters and difficulty levels associated with the one subcomponent skill, while leaving difficulty parameters related to the other subcomponent skills unchanged, during a sequence of simulations. Alternatively, the training program may challenge multiple subcomponent skills simultaneously by modifying difficulty parameters related to multiple subcomponent skills during a sequence of simulations. In an embodiment, the training program can challenge multiple subcomponent skills by changing a single difficulty parameter that is related to multiple subcomponent skills, by changing multiple difficulty parameters that are each related to a single subcomponent skill, or by a combination thereof.

As the user trains, program 300 may continuously monitor the performance of the user and adjust the difficulty level so that the appropriate subcomponent brain systems correlating to the subcomponent skill being trained are constantly challenged. Program 300 may do this by continuously or periodically measuring the user breakdown point, and modifying the difficulty level so that it is just above the performance level of the user. In this way, program 300 can maximize the effectiveness of the training by providing exercises that result in rapid and efficient neural adaptations in the brain.

As a user continues to train, his or her performance in particular subcomponent skills will likely increase. At some point, the user performance may plateau, or it may reach a threshold level where it is no longer a relatively weak skill. Accordingly, other subcomponent skills may become the weakest subcomponent skills. In order to continue training in the most effective manner, process 300 can re-tailor the training program so that it is weighted toward training the newly weakest subcomponent skills.

In an embodiment, training process 300 can choose to weight the training schedule to train subcomponent skills that have the most variability over a population. The high variability of these subcomponent skills can indicate that, even if the user is not weak in the subcomponent skill, there is room for the user to improve. Therefore, it may be relatively quick and easy to increase performance in those subcomponent skills through training. The high variability can also indicate that training in these areas will provide improvement in performance of the responsive skill. In some cases, even if a user does not show weakness in a subcomponent skill, but does show high variability, process 300 may weight training in that subcomponent skill because the high variability will likely result in rapid performance improvement.

Aside from training, process 300 can be used to track changes in user performance over time. For example, process 300 can measure a user performance over time, and correlate changes in performance to external stimulus, such as changes in diet or exercise routines, aging, nutrition, physical training, new technology, etc. Process 300 can also be used to track changes in performance due to pharmaceuticals, insult to visuo-motor brain systems, efficacy of therapeutics aimed at brain function, etc.

In some embodiments, process 300 can include simulation features that provide a richer simulation environment. These can include audiovisual effects that provide background to the simulation. In the case of batting, the simulation can include crowd and PA system sounds, overhead lights, music, etc. A football simulation could include a half-time simulation, realistic scoring, or replays of key scenarios, for example. Other simulations can include other appropriate audiovisual features as well. In some cases, if desired, the audiovisual effects can fade in or out so the user can concentrate on the training aspects of the simulation.

In some embodiments, process 300 can be a module in a 3rd party application. For example, a video game could include process 300 as a training module that a gamer can invoke in order to train. As another example, process 300 could be part of a larger training or educational program or application.

### EXAMPLES

### Batting

In an embodiment, process 300 presents a user with a GUI having choice of activities in which to train. Once the user chooses batting, process 300 displays a simulation of a baseball pitch. Process 300 may also display a screen of instructions informing the user of how to react. For example, the screen may instruct the user to press a button when the ball enters the strike zone.

Process 300 may then display the simulation and proceed with the PZD process.

Process 300 may, for instance, ramp up the difficulty of the simulation and record the reactions of the user, in order to measure the breakdown point at which the user began to fail.

Process 300 may then proceed with the PTI process to fine-tune the breakdown point measurement. For instance, process 300 may incrementally increase and decrease the difficulty of the simulation about the measured breakdown point in order to obtain a more accurate reading of the breakdown point.

Process 300 may repeat the PZD and PTI processes for various subcomponent skills related to batting. Once performance in the subcomponent skills has been measured, process 300 may identify which subcomponent skills are strengths, and which are weaknesses for the user. In some instances, process 300 may identify the strengths and weaknesses by comparing the user performance to the performance of a sample population of users.

Process 300 may then provide a training schedule that weights training toward the subcomponent skills in which the user shows a weakness. The user can then use process 300 to practice and improve his or her performance in batting, and/or the subcomponent skills related to batting. In some cases, the user can use process 300 to train on a laptop, a mobile device, a game console, a computer, or any other wired or wireless computing device.

### Avoiding a Tackle

In an embodiment, process 300 presents a user with a GUI having choice of activities in which to train. Once the user chooses avoiding a tackle, process 300 displays a simulation of a football play where the user is the ball carrier. Process 300 may also display a screen of instructions informing the user of how to react. For example, the screen may instruct the user to press a left arrow to run left to avoid a tackle, or a right arrow to run right to avoid a tackle, etc.

Process 300 may then display the simulation and proceed with the PZD process. Process 300 may, for instance, ramp up the difficulty of the simulation in various subcomponent skills such as timing, choosing a direction to run, and the like. Process 300 may also record the reactions of the user, in order to measure the breakdown point at which the user began to fail.

Process 300 may then proceed with the PTI process to fine-tune the breakdown point measurement. For instance, process 300 may incrementally increase and decrease the difficulty of the simulation about the measured breakdown point in order to obtain a more accurate reading of the breakdown point.

Process 300 may repeat the PZD and PTI processes for various subcomponent skills related to avoiding a tackle, such as choice of direction. Once performance in the subcomponent skills has been measured, process 300 may identify which subcomponent skills are strengths, and which are weaknesses for the user. In some instances, process 300 may identify the strengths and weaknesses by comparing the user performance to the performance of a sample population of users.

Process 300 may then provide a training schedule that weights training toward the subcomponent skills in which the user shows a weakness. The user can then use process 300 to practice and improve his or her performance in avoiding a tackle, and/or the subcomponent skills related to avoiding a tackle. In some cases, the user can use process 300 to train on a laptop, a mobile device, a game console, a computer, or any other wired or wireless computing device.

### Musical Improvisation

In an embodiment, process 300 presents a user with a GUI having choice of activities in which to train. Once the user chooses musical improvisation, process 300 can play a musical score through a speaker, for example, and record notes played or sung by the user through a microphone. Process 300 may also display a screen of instructions informing the user of how to react. For example, the screen may tell a user to play improvised music and try to remain within key, and within timing.

Process 300 may then play the simulation and proceed with the PZD process.

Process 300 may, for instance, ramp up the difficulty of the simulation in various subcomponent skills by, for example, changing the timing of the music being played, changing the key of the music being played, and the like. Process 300 may also record the reactions of the user, i.e. notes played by the user and whether the user was able to play notes that are in key or within a required timing, in order to measure the breakdown point at which the user began to fail.

Process 300 may then proceed with the PTI process to fine-tune the breakdown point measurement. For instance, process 300 may incrementally increase and decrease the difficulty of the simulation about the measured breakdown point in order to obtain a more accurate reading of the breakdown point.

Process 300 may repeat the PZD and PTI processes for various subcomponent skills related to musical improvisation, such as timing and proper key. Once performance in the subcomponent skills has been measured, process 300 may identify which subcomponent skills are strengths, and which are weaknesses for the user. In some instances, process 300 may identify the strengths and weaknesses by comparing the user performance to the performance of a sample population of users.

Process 300 may then provide a training schedule that weights training toward the subcomponent skills in which the user shows a weakness. The user can then use process 300 to practice and improve his or her performance in musical improvisation, and/or the subcomponent skills related to musical improvisation. In some cases, the user can use process 300 to train on a laptop, a mobile device, a game console, a computer, or any other wired or wireless computing device.

Various implementations of the systems and techniques described here can be realized in digital electronic circuitry, integrated circuitry, specially designed ASICs (application-specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device. Such computer programs (also known as programs, software, software applications or code) may include machine instructions for a programmable processor, and may be implemented in any form of programming language, including high-level procedural and/or object-oriented programming languages, and/or in assembly/machine languages. A computer program may be deployed in any form, including as a stand-alone program, or as a module, component, subroutine, or other unit suitable for use in a computing environment. A computer program may be deployed to be executed or interpreted on one computer or on multiple computers at one site, or distributed across multiple sites and interconnected by a communication network.

A computer program may, in an embodiment, be stored on a computer readable storage medium. A computer readable storage medium stores computer data, which data can include computer program code that is executed and/or interpreted by a computer system or processor. By way of example, and not limitation, a computer readable medium may comprise computer readable storage media, for tangible or fixed storage of data, or communication media for transient interpretation of code-containing signals. Computer readable storage media, may refer to physical or tangible storage (as opposed to signals) and may include without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

The present disclosure makes reference to various block diagrams and flowcharts.

One skilled in the art will recognize that the order and configuration of components in the block diagrams and steps in the flowcharts are not limitations and are provided for illustration only. Various appropriate configurations of components and devices, and various orders and sequences of operation may fall within the scope of the claims.

It will be understood that synonymous terms in the claims (e.g. terms such as effectuate, create, open, connect, actualize, produce, etc.) may be intended to have synonymous meaning Different, but synonymous, terms in the claims may be used for clarity in identifying, for example, steps within a method claim or elements within an apparatus claim.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

1. A method for training, the method comprising:
presenting to a user, via a computing device, a simulation, eliciting from the user a response, reflective of the user performing a macro-level response skill for which training is desired, the performance of the macro-level response skill by the user including at least one of a plurality of subcomponent response skills, each subcomponent response skill correlating to at least one of a plurality of brain systems underlying the respective subcomponent response skill;
identifying a brain system from the plurality of brain systems underlying the respective subcomponent skill and for which training is desired; and
providing, via the computing device, training for the user, in the macro-level response skill, by focusing training on the identified brain system underlying the respective subcomponent responsive skill.

2. (canceled)

3. (canceled)

4. A method as set forth in claim 1, further comprising analyzing, via the computing device, at least one response by the user in order to determine a threshold performance level of the user in at least one of the plurality of subcomponent response skills including providing a pass/fail criteria for the simulation that can be used to measure a difficulty level at which the user fails at the simulation, so as to determine the threshold performance level of the user.

5. A method as set forth in claim 4, wherein the step of analyzing further includes fine-tuning the threshold performance level by incrementally adjusting the level of difficulty in either direction from the threshold performance level, and measuring whether the user passed or failed the simulation at the adjusted level of difficulty, in order to obtain a more accurate measurement of the threshold performance level.

6. A method as set forth in claim 1, further comprising analyzing, via the computing device, at least one response by the user in order to determine a threshold performance level of the user in at least one of the plurality of subcomponent response skills including including measuring a plurality of threshold performance levels and comparing them to historical performance levels of a baseline population in order to identify a set of subcomponent skills in which the user is weak or strong.

7. A method as set forth in claim 6, wherein the baseline population is a group of elite performer of the responsive skill so that the threshold performance levels of the user are compared to elite performance levels in order to identify a set of subcomponent skills in which the user is weak.

8. A method as set forth in claim 6, wherein the step of analyzing further includes identifying a set of subcomponent skills in which the user is weak or strong based on a distance between the threshold performance levels of the user and the historical performance levels of the baseline population.

9. A method as set forth in claim 1, wherein the step of providing includes weighting the a training program toward those subcomponent skills in which the user is weak, so that use of the training program will improve performance of the user by providing focused training in those subcomponent skills.

10. A method as set forth in claim 9, wherein the step of weighting the training program includes adjusting a length or frequency of training in a weak subcomponent skill so that the user receives more effective training in the weak subcomponent skill.

11. A method as set forth in claim 1, wherein the step of providing includes continuously or periodically adjusting the difficulty level as performance threshold of the user changes, so that the user is continuously challenged by the simulation and can continue to increase performance through use of the simulation.

12. A method as set forth in claim 1, further comprising storing a current threshold performance level of the user in a memory once a training session ends, so that such threshold performance level can be used for subsequent training sessions.

13. A method as set forth in claim 1, wherein the simulation is used for one of: training a sensory-motor skill, training of a non-sensory motor skill, training of a sport activity, training of a non-sport activity, medical rehabilitation, or a combination thereof.

14. A method as set forth in claim 1, further comprising making the threshold performance level of the user available so that a scout can compare the ability and/or potential of the user to other possible recruits.

15. A method as set forth in claim 1, further comprising making data representing the threshold performance level of the user available so that a trainer can create a custom training program for the user.

16. A method as set forth in claim 1, further comprising making data representing the threshold performance level of the user available so that a trainer can monitor the performance level of the user over time, as the user continues to use the simulation.

17. A computer readable medium storing instructions that, when executed by a computing device, cause the computing device to perform a method, the method comprising:
presenting to a user, via a computing device, a simulation, eliciting from the user a response, reflective of the user performing a macro-level response skill for which training is desired, the performance of the macro-level response skill by the user including at least one of a plurality of subcomponent response skills, each subcomponent response skill correlating to at least one of a plurality of brain systems underlying the respective subcomponent response skill;
identifying a brain system from the plurality of brain systems underlying the respective subcomponent skill and for which training is desired; and
providing, via the computing device, training for the user in the macro-level response skill by focusing training on the identified brain system underlying the respective subcomponent responsive skill.

18. A computer readable medium as set forth in claim 17, further comprising analyzing at least one response by the user in order to determine a threshold performance level of the user in at least one of a plurality of subcomponent response skills wherein the step of analyzing includes providing a pass/fail criteria for the simulation that can be used to measure a difficulty level at which the user fails at the simulation, so as to determine the threshold performance level of the user.

19. A computer readable medium as set forth in claim 18, wherein the step of analyzing further includes fine-tuning the threshold performance level by incrementally adjusting the level of difficulty in either direction from the threshold performance level, and measuring whether the user passed or failed the simulation at the adjusted level of difficulty, in order to obtain a more accurate measurement of the threshold performance level.

20. A computer readable medium as set forth in claim 17, wherein the step of analyzing includes measuring a plurality of threshold performance levels and comparing them to historical performance levels of a baseline population in order to identify a set of subcomponent response skills in which the user is weak.

21. A computer readable medium as set forth in claim 20, further comprising generating a training program weighted toward those subcomponent response skills in which the user is weak, so that use of the training program will improve performance of the user by providing focused training in those subcomponent skills.

22. A computer readable medium as set forth in claim 17, further comprising storing a current threshold performance level of the user in a memory once a training session ends, so that such threshold performance level can be used for subsequent training sessions.

23. A computer readable medium as set forth in claim 17, wherein the simulation is used for one of: training of a sport activity, training of a non-sport activity, medical rehabilitation, or a combination thereof

24. A method for enhancing training effectiveness, the method comprising:
analyzing, via a computing device, a response by the user to a simulation in order to determine a threshold performance level of the user for at least one of a plurality of brain systems underlying at least one of a plurality of subcomponent response skills associated with a macro-level response skill for which training is desired;
based on the threshold performance level, identifying, via the computing device, one brain system from the plurality of brain systems for which training is to be implemented; and
providing to the user, via the computing device, a training program targeting the identified brain system underlying the respective subcomponent response skill, so as to enhance performance of the associated macro-level response skill.

25. A method as set forth in claim 1, wherein the step of providing training for the user includes allowing the user to choose the subcomponent skill in which to train so that the user can target a specific brain system in which to improve performance.

26. A method as set forth in claim 1, wherein the step of providing includes tailoring the program to improve performance of the user in the brain system, so that subsequent use of the training program enhances the performance of the macro-level response skill.

27. A method as set forth in claim 1, further comprising analyzing, via the computing device, one of user response variability, other similar user performance characteristics, user external measurements, or a combination thereof to determine a threshold performance level of the user in at least one of the plurality of subcomponent response skills.
